(19) United States
(12) Patent Application Publication
(10) Pub. No.: US 2016/0314108 A1
(43) Pub. Date: Oct. 27, 2016

(54) APPARATUS, METHOD, AND COMPUTER PROGRAM PRODUCT FOR GENERATING A LADDER-LOGIC PROGRAM

(71) Applicant: KABUSHIKI KAISHA YASKAWA DENKI, Kitakyushu-shi (JP)

(72) Inventor: Naoki MIZUNO, Kitakyushu-shi (JP)

(73) Assignee: KABUSHIKI KAISHA YASKAWA DENKI, Kitakyushu-shi (JP)

(21) Appl. No.: 15/134,995

(22) Filed: Apr. 21, 2016

(30) Foreign Application Priority Data
Apr. 21, 2015 (JP) 2015-087134

(51) Int. Cl. G06F 17/24

(52) U.S. Cl. CPC G06F 17/241

(57) ABSTRACT

An apparatus for generating a ladder-logic program includes a comment adder, an annotation information adder, a ladder-logic chart display manager, and a display controller. The comment adder adds one or more comments, each of which includes text information, to the ladder-logic program. The annotation information adder adds annotation information, pertaining to display of the ladder-logic program, to at least one of the one or more comments. The ladder-logic chart display manager displays a ladder-logic chart and the text information included in each of the one or more comments, based on the ladder-logic program. The display controller controls display performed by the ladder-logic chart display manager, based on the annotation information added to the at least one of the one or more comments.

### CROSS-REFERENCE TO RELATED APPLICATIONS

This disclosure is based upon and claims under 35 U.S.C. §119 the benefit of priority of the prior Japanese Patent Application, No. 2015-087134 filed on Apr. 21, 2015 in the Japanese Patent Office, the entire contents of which are hereby incorporated by reference.

### BACKGROUND

1. Field of the Invention

The present disclosure relates to an apparatus, method, and computer program product for generating a ladder-logic program.

2. Discussion of the Background

Industrial machine are usually operated under the control of a controller. As a tool for describing an operation of such a controller, a ladder-logic chart drawn with a ladder-logic language is widely used.

A variety of computer application software has been introduced to assist in creating such a ladder-logic chart. The contents of the ladder-logic chart are referred to as a ladder-logic program. In general, there is a difficulty to understand by a glance what operation each line in the ladder -logic chart expresses. Some of the application software allows users, when creating a ladder-logic program, to add suitable comments in order to provide a simple description of a symbolized operation of each line in the ladder-logic chart.

### SUMMARY

This specification describes a novel apparatus for generating a ladder-logic program includes a comment adder, an annotation information adder, a ladder-logic chart display manager, and a display controller. The comment adder adds one or more comments, each of which includes text information, to the ladder-logic program. The annotation information adder adds annotation information, pertaining to display of the ladder-logic program, to at least one of the one or more comments. The ladder-logic chart display manager displays a ladder-logic chart and the text information included in each of the one or more comments, based on the ladder-logic program. The display controller controls display performed by the ladder-logic chart display manager, based on the annotation information added to the at least one of the one or more comments.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic block diagram illustrating an exemplary physical structure of a ladder-logic program generating apparatus according to an exemplary embodiment;

FIG. 2 is a schematic functional block diagram illustrating an exemplary functional structure of the ladder-logic program generating apparatus illustrated in FIG. 1;

FIG. 3 is an exemplary screen image displayed on a monitoring display of the ladder-logic program generating apparatus illustrated in FIG. 1;

FIG. 4 is an exemplary structural image of data of annotation information when the annotation information is a bookmark;

FIG. 5 is a schematic diagram of an exemplary human-readable document output by the ladder-logic program generating apparatus of FIG. 1;

FIG. 6 is a schematic diagram for explaining exemplary manners for designating a sequence and a layer of an annotation name;

FIG. 7 is a schematic diagram of an exemplary basic human-readable document that is generated and output in a state of being presented in a display area for displaying annotation information;

FIG. 8 is an exemplary screen image displayed on a monitoring display of the ladder-logic program generating apparatus illustrated in FIG. 1, when a ladder-logic program is generated based on the basic human-readable document of FIG. 7;

FIG. 9 is a schematic block diagram of an exemplary functional structure of a ladder-logic program generating apparatus according to an exemplary variation of the ladder-logic program generating apparatus illustrated in FIG. 1;

FIG. 10 is an exemplary screen image displayed on a monitoring display of the ladder-logic program generating apparatus illustrated in FIG. 9;

FIG. 11 is a flowchart illustrating an exemplary procedure of a basic operation performed by the ladder-logic program generating apparatus of FIG. 1;

FIG. 12 is a flowchart illustrating an exemplary procedure of a program selecting operation following the basic operation of FIG. 11;

FIG. 13 is a flowchart illustrating an exemplary procedure of an annotation-information selecting operation following the basic operation of FIG. 11;

FIG. 14 is a flowchart illustrating an exemplary procedure of a ladder-command inputting operation following the basic operation of FIG. 11;

FIG. 15 is a flowchart illustrating an exemplary procedure of an annotation-information adding operation following the basic operation of FIG. 11;

FIG. 16 is a flowchart illustrating an exemplary procedure of a comment adding operation following the basic operation of FIG. 11;

FIG. 17 is a flowchart illustrating an exemplary procedure of a position-and-layer designating operation following the basic operation of FIG. 11;

FIG. 18 is a flowchart illustrating an exemplary procedure of a human-readable document outputting operation following the basic operation of FIG. 11; and

FIG. 19 is a flowchart illustrating an exemplary procedure of a basic-human-readable-document reading operation following the basic operation of FIG. 11.

### DESCRIPTION OF THE EMBODIMENTS

According to the inventor, existing apparatuses, software, and controllers for assisting in the creation of a ladder-logic program have a drawback of being not capable of allowing a user to search embedded comments and a target part in a ladder-logic chart, and, as a result, the work efficiency greatly suffers when the ladder-logic program is relatively large.

An attempt is made to newly implement a bookmarking system for performing a quick search in the apparatus. With the bookmarking system, a bookmark represents annotation information regarding a position in the ladder-logic program and is embedded in the ladder-logic program. However, this may causes an impairment of compatibility as another drawback in that existing systems cannot interpret the newly added annotation information.

Under such circumstances, the inventor has been diligently working on the research and development of an apparatus for generating a ladder-logic program, and eventually provides a novel apparatus for generating a ladder-logic program which is capable of newly adding annotation information in the ladder-logic program and maintaining compatibility with existing systems.

Embodiments of apparatus, method, and computer program products, for generating a ladder-logic program, disclosed in this application will be described in detail below with reference to the accompanying drawings. These apparatus, method, and computer program products for generating a ladder-logic program are not limited to the embodiments given hereunder.

In this disclosure, a term “ladder-logic chart” (hereinafter referred to as “LL-chart”) represents a chart drawn using a ladder language. A term “ladder-logic program” (hereinafter referred to as “LL-program”) represents contents drawn in the LL-chart. Also, a term “ladder-logic command” (hereinafter referred to as “LL-command”) represents an individual instruction in the LL-program.

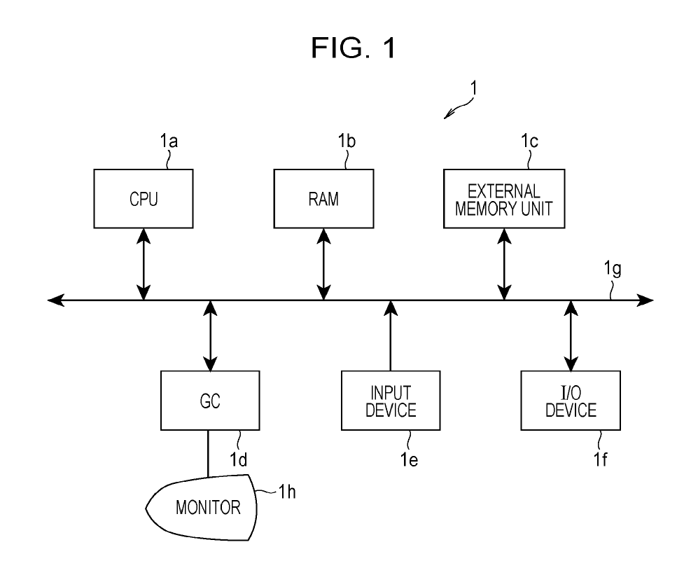

FIG. 1 is a schematic block diagram illustrating an exemplary physical structure of an LL-program generating apparatus 1 according to an exemplary embodiment. The LL-program generating apparatus 1 of FIG. 1 can be implemented by a general computer.

As illustrated in FIG. 1, the LL-program generating apparatus 1, which is implemented by a general computer, includes a CPU (central processing unit) 1a, a RAM (random access memory) 1b, an external memory unit 1c, a GC (graphics controller) 1d, an input device 1e, an I/O (input and output) device 1f, a data bus 1g, and a monitor 1h.

In the LL-program generating apparatus 1, each of the above-mentioned devices, except for the monitor 1h, is connected to the data bus 1g so that the devices are able to exchange electrical signals with each other.

The external memory unit 1c includes, for example, a HDD (hard disk drive), an SSD (solid state drive), or the like, each of which is a memory device capable of statically recording information.

The GC ld sends a signal to the monitor 1h and the monitor 1h displays an image thereon. The monitor 1h includes, for example, a CTR (cathode ray tube), a flat panel display, or the like, on which an operator visually recognizes an image.

The input device le includes, for example, a keyboard or a pointing device including a mouse or a touch panel, for users to input information. The I/O device if acts as an interface for the LL-program generating apparatus 1 to exchange information with external devices.

An application program that makes a computer act as the LL-program generating apparatus 1 is installed in the external memory unit 1c. On an as-needed basis, the CPU 1a reads the application program from the external unit 1c to the RAM 1b and executes it. The application program may be provided to the LL-program generating apparatus 1 via a computer readable information recording medium such as an optical disk, a magneto-optical disk, a flash memory, and so forth, or via an information communication line such as the Internet, according to circumstances.

When the LL-program generating apparatus 1 is connected to an external PLC (programmable logic controller) (not shown), a LL-program generated by the LL-program generating apparatus 1 may be transferred to the external PLC through the I/O device 1f, and the external PLC may execute the LL-program.

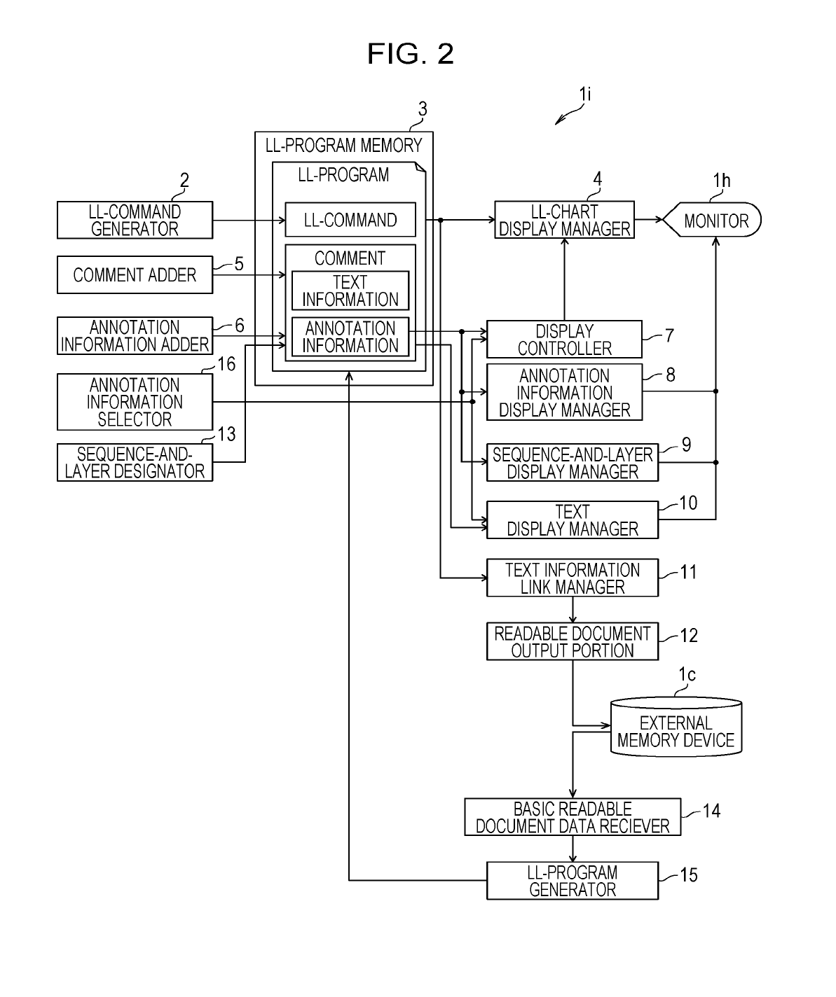

FIG. 2 is a schematic functional block diagram illustrating an exemplary functional structure of the LL-program generating apparatus 1 of FIG. 1. Each one of the function blocks in FIG. 2 is virtually carried out by using the elements of the physical structure of the LL-program generating apparatus 1; for example, by causing the CPU la to execute a predetermined program, or allocating a memory area for storing designated information to the RAM 1b or the external memory device 1c. That is, in FIG. 2, the schematic functional block diagram is created by focusing on the functions of the LL-program generating apparatus 1.

Therefore, the function blocks of FIG. 2 does not directly correspond to the physical structure of the LL-program generating apparatus 1 and to blocks of a program executed by the LL-program generating apparatus 1 even when such program is divided into function blocks.

Furthermore, in FIG. 2, some of the function blocks having not much connection to the present embodiment are omitted. Thus, the entire function blocks of the LL-program generating apparatus 1 are not necessarily presented in the function block diagram of FIG. 2.

In this disclosure, entire elements of FIG. 2, except for the external memory unit 1c and the monitor 1h, are collectively referred to as a virtual function block structure 1i. The virtual function block structure 1i includes a LL-command generator 2, a LL-program memory 3, a LL-chart display manager 4, a comment adder 5, an annotation information adder 6, a display controller 7, an annotation information display manager 8, and a sequence-and-layer display manager 9. The virtual function block structure 1i further includes a text display manager 10, a text information link manager 11, a readable document output portion 12, a sequence-and-layer designator 13, a document data receiver 14, a LL-program generator 15, and an annotation information selector 16.

The LL-program memory 3 stores a “LL-program”. The LL-program includes a “LL-command” and a “comment”. The “comment” includes “text information” and “annotation information”.

The LL-program generating apparatus 1 is provided with a GUI (graphical user interface) and enters the “LL-command” through the GUI, so as to realize the function for creating the “LL-program”. More specifically, the LL-program generating apparatus 1 causes the LL-command generator 2 to appropriately generate and enter the “LL-commands” to create the “LL-program”.

The LL-command generator 2 generates a set of “LL-commands” stores them as a “LL-program” in the LL-program memory 3. The LL-chart display manager 4 displays such a set of “LL-commands” as an “LL-chart” on the monitor 1h. The “LL-command” is an individual instruction as a part of the “LL-program”, and is expressed, on the monitor 1h, in a form of various kinds of figure such as a contact point, a timer, a coil, a branch, etc. that form the “LL-chart”.

In the present embodiment, the “LL-command” of the “LL-program” is an instruction to be interpreted and executed by the external PLC so as to control activation of various kinds of external machines (not shown). The “comment” of the “LL-program” is ignored by the external PLC and does not affect control of activation of external machines.

The comment adder 5 adds the “comment” to the “LL-program” stored in the LL-program memory 3. The “comment” includes the “text information” and the “annotation information”; they are of a user-editable simple text so that a user can freely use it as, for example, a remark, etc.

The annotation information adder 6 adds the “annotation information” to the “comment” of the “LL-program”. Although the “annotation information” relates to information with respect to display of the “LL-program”, the “annotation information” includes information to be displayed as a simple text and different information to be interpreted by the LL-program generating apparatus 1 so that a predetermined operation is performed. Thus, information of the “annotation information” is treated in a relatively irregular manner.

The “annotation information” is added to the “comment” in a way to be distinguishable from the “text information” contained in the “comment”. As one example, an area of the “annotation information” in the “comment” may be specified by using a markup language.

The “annotation information” may include various kinds of information including, such as, for example, information to be treated by using a bookmark, information regarding formats of “LL-charts” and “comments”, information regarding metadata such as series of versions and correction histories with respect to “LL-programs”, information defining access rights for the purposes of viewing and editing in accordance with users, and so on.

Each piece of the above-mentioned information may further include information characterizing itself. For example, when the information is a bookmark, the bookmark may include, as described in detail later, pieces of information representing, for example, an identifier, a name, a sequence and a layer, a hidden text, date designating information, and text data position information. When the information is a correction history, the information of the correction history may include “LL-commands” before and after, a correction date, and a corrector's name, for example. When the information is in regard to a format, it may include various format instructions such as display colors, a revers mode, underlines, target areas, etc.

As described above, the LL-chart display manager 4 displays the “LL-command” of the “LL-program” stored in the LL-program memory 3 on the monitor 1h, as the “LL-chart”. In addition, the LL-chart display manager 4 displays the “text information” included in the “comment” of the “LL-program” on the monitor 1h, as a text. This text being displayed on the monitor 1h is located in the “LL-chart” at a position corresponding to a position at which the “comment” is located in the “LL-program”. The “text information” of the “LL-chart” may or may not be displayed; that is, a user can arbitrarily switch from one mode to the other.

As is different from the case of the “text information”, the “annotation information” of the “comment” is not directly displayed as a text on the monitor 1h, but is first interpreted by the display controller 7. In accordance with the result of the interpretation, the display controller 7 controls the LL-chart display 4 based on the “annotation information”, in ways of changing and managing a style of an image of the “LL-chart”.

As an example of changing a style of an image of the “LL-chart”, when the “annotation information” is format-related information, the display controller 7 accordingly changes a format-related display style such as a color, a font, etc. of the “LL-chart” and text to be displayed on the monitor 1h by the LL-chart display manager 4. When the “annotation information” is the above-mentioned bookmark, as is explained in detail below with examples, a mark for indicating a bookmark is placed at a specific position in the “LL-chart” and, when a bookmark selection is activated, an image of the “LL-chart” indicating the bookmark at the specific position is to be displayed, so that the style of an image of the “LL-chart” is changed.

As an example of managing a style of an image of the “LL-chart”, when the “annotation information” is the above-mentioned authority information or a revision history, the “LL-chart” or a text is displayed, or, a part or a whole is hidden from view, in accordance with the information of the “annotation information”.

In this way, the LL-program generating apparatus 1 can control images of the “LL-chart” and text displayed by the LL-chart display manager 4 in accordance with the “annotation information” that is added to the “LL-program”. In addition, since the “annotation information” is included in the “comment”, as described above, the “annotation information” is treated merely as a part of the comment by existing software for assisting creation of “LL-chart” and is ignored by the PLC in existence. Therefore, the “annotation information” newly added to the “LL-program” may not arise compatibility problems between the “LL-program” and any existing LL-program.

The annotation information display manager 8 displays a plurality of the “annotation information”, by gathering at least part of each one of the plurality of the “annotation information” in list form, at an area different from display areas for the “LL-chart” and the “comment” in the monitor 1h. Such a list form enables a user to browse a plurality of the “annotation information” added to the “LL-program”. Accordingly, information to identify the “annotation information”, for example, an annotation name of each one of the plurality of the “annotation information” may be appropriate to be shown in list form. For easier identification, the annotation name may be input by a user or created automatically by the LL-program generating apparatus 1.

In the above-described list form of the “annotation information”, an annotation name may be associated with a program name representing the LL-program to which the present “annotation information” is added. A sequence of the annotation names in list form may correspond to the positions of the “annotation information” included in the “LL-program”. Further details of the list form displayed by the annotation information display manager 8 will be described later.

The LL-program generating apparatus 1 is, as described below, capable of designating a sequence and a layer of the “annotation information”, independently from a position of this particular “annotation information” in the “LL-program” in an editing operation. For this purpose, the LL-program generating apparatus 1 is provided with the sequence-and-layer display manager 9, in addition to the annotation information display manager 8. The sequence-and-layer display manager 9 displays the annotation names in the list form in a way such that the designated sequence and the layer with respect to the “annotation information” are clearly indicated.

Therefore, the sequence of the annotation names displayed by the sequence-and-layer display manager 9 may not necessarily be in accordance with the positions of the corresponding, but in accordance with the designated sequence. Also, the annotation names may not necessarily be given to every one of the “annotation information” but to those that are relatively easier to be designated with the sequence and layer. More details of the contents by the sequence-and-layer display manager 9 will be described later.

The annotation information selector 16 selects at least one “annotation information” out of at least one part of one or more “annotation information” displayed in list form on the monitor 1h. The annotation information selector 16 may be activated for this selection by a user on the monitor 1h with using an input device such as a pointing device, for example. As a result, the selected “annotation information” is transferred to the display controller 7, and the display controller 7 use it to control the display of the LL-chart display manager 4. For example, when the “annotation information” is a bookmark, the display controller 7 controls the LL-chart display manager 4 to display the part of the “LL-chart” designated by the bookmark. When seeing this operation from the user view point, an arbitrary bookmark is selected from the list form on the monitor 1h and this selection causes a rapid display, on the monitor 1h, of a part of the “LL-chart” designated by that bookmark selected.

The “annotation information” selected by the annotation information selector 16 is transferred to the text display manager 10. The selected “annotation information” may include information that a user may need. The text display manager 10 displays such information needed by a user in text at any position on the monitor 1h.

Here, the LL-program generating apparatus 1 can be conducted to perform an automatic operation by a user instruction or under predetermined circumstances such as timing or conditions. At this time, the “text information” link manager 11 and the readable document output portion 12 generate, in collaboration, a readable document based on the LL-program stored in the LL-program memory 3 and output it.

The readable document is defined as a document that is described in a natural language and that is capable of being read and understood by a user. The LL-program generating apparatus 1 is configured specifically to generate and output a readable document that includes a text appropriately divided into blocks. Accordingly, the text information link manager 11 links, at least, the “text information” included in the “comment” to the respective “annotation information” added to this “comment”. The readable document output portion 12 outputs, at least, the “text information” as a readable document having a format such that the “text information” is identifiable by each one of the “annotation information” linked thereto.

That is, the above-described sequential operations by the text information link manager 11 and the readable document output portion 12 generate a readable document in which the text is divided into blocks in a unit of the “annotation information”. One block of text includes, at least, the “text information” included in the “comment” to which the corresponding “annotation information” is added. So, the “comment” which is arbitrarily added to the “LL-program” can be extracted as a readable document divided in blocks of the “annotation information”. By using this mechanism, a specification and an explanation for the “LL-program” can be inserted into an area needed in the “LL-program” by using the “comment”, and the “annotation information” can also be inserted on an as-needed basis. Thereby, a document of specification, explanation, or the like that divided in blocks and is superior in readability can be automatically generated.

The text information link manager 11 can link some other information than the above-mentioned corresponding “text information” to the “annotation information”. For example, a hidden text may be linked to the “annotation information”. The hidden text is defined as a text that is not inserted in the “LL-chart” to be displayed by the LL-chart display manager 4 and that is to be included in the “comment” but differentiated from the “text information”.

In the LL-program generating apparatus 1, the hidden text is to be included in the “annotation information” and arbitrarily usable by a user. An exemplary use of the hidden text may be an explanation or remark to the “annotation information”, or, a memorandum, etc. The hidden text may be displayed in a form separated from the “LL-chart” and may be editable.

The readable document output portion 12 may output a generated readable document in an arbitrary form. For example, as readable document data in an arbitrary electrical data form, the readable document may be transferred to and saved in the external memory unit 1c. Otherwise, the readable document may be output to one of a printer so as to be printed on a paper medium and the monitor 1h so as to be viewed on the monitor 1h. These output form may be selected by a user.

Further, the LL-program generating apparatus 1 may have a function for changing the sequence and the layer of the “annotation information” which are incorporated in the readable document. The sequence-and-layer designator 13 is provided for this purpose, and designates both of the sequence and the layer for each one of the annotation name displayed in a list form by the sequence-and-layer display manager 9. As an alternative, the sequence-and-layer designator 13 may designate one of the sequence and the layer for each one of the annotation name displayed in a list form by the sequence-and-layer display manager 9.

The sequence and the layer designated for each one of the annotation names by the sequence-and-layer designator 13 are recorded in the corresponding each one of the “annotation information”, and the readable document output portion 12 outputs the readable document based on the designated sequence and the layer.

Although details will be explained later, the above-description means that, by designating the sequence and the layer for each one of the “annotation information” by the sequence-and-layer designator 13, the sequence of the “annotation information” in the readable document can be designated, and also the readable document can be layered.

That is, when the “LL-program” is provided with a text on an as-needed basis, the sequence that the texts appear in the “LL-program” may not always be appropriate for a user to read and understand such texts to be read as the readable document. So, the LL-program generating apparatus 1 designates the sequence of the “annotation information” in the readable document so that the sequence of the block-divided text in the readable document is changed independently of the sequence in the “LL-program”, thereby greatly enhancing readability of the readable document. In addition, by designating the layer for each one of the “annotation information”, the readable document can be made in a layered structure, thereby further greatly enhancing the readability of the readable document.

In the description made thus far, the LL-program generating apparatus 1 is configured to generate and output the readable document by using the “text information” and the “annotation information” in the “comment” added to the “LL-program”. The LL-program generating apparatus 1 may have a function for receiving a previously-prepared readable document (hereinafter referred to as a basic readable document) and generating, based on such a basic readable document, the “LL-program” accordingly having the “comment” with the “annotation information”.

Here, the LL-program generating apparatus 1 is provided with the document data receiver 14 and the LL-program generator 15. The document data receiver 14 receives basic readable document data, which is the basic readable document in an electrical data form, from the external memory unit 1c.

The basic readable document is a readable document that is previously prepared and has texts appropriately divided in a plurality of blocks. Each one of the plurality of blocks of the texts in the basic readable document is hereinafter referred to as a block text. So, the basic readable document is referred to as a readable document that includes a plurality of block texts, or at least one, in a differentiating form from each other.

The LL-program generator 15 generates the “comment” for each one of the plurality of block texts included in the received basic readable document data. The “text information” and the “annotation information” included in the generated “comment” are made in accordance with the contents of the block text. Consequently, the LL-program generator 15 generates an uncompleted LL-program merely having the “comment”. The generated uncompleted LL-program is stored in the LL-program memory unit 3 and displayed on the monitor 1h by the LL-chart display manager 4.

As is clear by the above description, the uncompleted LL-program generated by the LL-program generator 15 cannot directly be read and executed by the PLC to control operations of external machines, but can be of great use for a user to create the “LL-program”. That is, when the “LL-program” is created under the circumstance that the specification and the explanation are previously determined and documented, the LL-program generator 15 uses this previously created document as the basic readable document to generate an uncompleted readable document accordingly. Subsequently, the uncompleted readable document having an addition of the “comment” with the above-mentioned specification and explanation is displayed, as a template of the “LL-program”, on the monitor 1h. Since the “comment” with the specification and explanation is divided in the plurality of block texts, that is, having a plurality of sections, a user can easily refer the “comments” on the monitor 1h to create the “LL-program” in accordance with the specification and the explanation, thereby greatly improving the efficiency of creation of the “LL-program”.

In addition, since a user can create the “LL-program” along with the above-mentioned template for the “LL-program”, errors in the “LL-program” due to an unintended oversight in reading the specification and explanation can be greatly reduced. Further, when the “annotation information” generated for each one of the plurality of block texts is a bookmark, a user can directly refer the uncompleted LL-program at a position designated by the bookmark, thereby greatly reducing a load of creating the “LL-program”.

The LL-program generator 15 that generates, as described above, an uncompleted LL-program merely having the “comment” based on the basic readable document data may have a further function for creating an adequate “LL-command”. For example, the LL-program generator 15 may automatically create and add the “LL-command” that is repeatedly needed from the specification-wise: for example, a label, a self-holding circuit, etc.

Next, an exemplary operation performed by the above-described LL-program generating apparatus 1 is explained with reference to an exemplary screen image displayed on the monitor 1h.

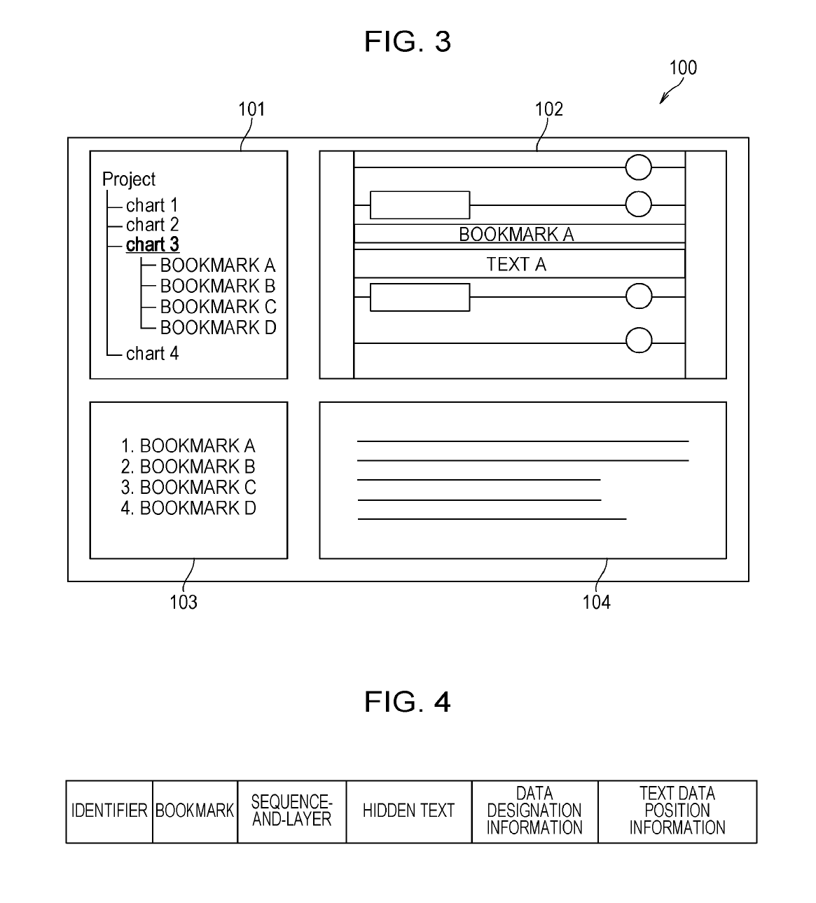

FIG. 3 illustrates a screen image 100 displayed on the monitor 1h of the LL-program generating apparatus 1. As illustrated in FIG. 3, the screen image 100 includes four image areas 101-104.

The image area 101 is a display image area for indicating information relating to a “project” that includes under its umbrella a plurality of “LL-programs” including the “LL-program” in an editing operation. Here, the “project” is defined as a group of one or more of the LL-programs having contents related to each other.

FIG. 3 indicates that the “project” being focused has, under its umbrella, four “LL-programs”. These four “LL-programs” are given names of “chart 1” to “chart 4” and are positioned in a layered form under a head, i.e., the “project”. So, hereinafter, when one of the “chart 1” to “chart 4” is cited, each one means not only the name of the corresponding “LL-program”, but also “LL-program” itself.

The “LL-program” in an editing operation is presented with its name in an emphasized display mode in the image area 101. When the “LL-program” in an editing operation is the “chart 3”, for example, the “chart 3” in the image area 101 is subjected to the emphasized display mode and may be highlighted, for example. In FIG. 3, for convenient sake, the “chart 3” is bolded and underlined as in the emphasized display mode. The term “emphasized display mode” used in this disclosure means a display style in which a subject element can be distinguished from other elements.

The image area 102 is a display image area for indicating the “LL-program” that is currently being edited as the “LL-chart”. Since the “LL-program” usually has a relatively long length and cannot be displayed at a time on the monitor 1h, a part of the “LL-program” is displayed in the image area 102, as illustrated in FIG. 3. That is, in FIG. 3, the “chart 3” which is the “LL-program” currently being edited is partly displayed.

The LL-chart display manager 4 inserts a “text A” of the “text information” of the “comment” included in the “LL-program” currently being edited, and displays such “text A” in the image area 102. That is, as illustrated in FIG. 3, the LL-chart display manager 4 inserts and displays the “text A” in the “LL-chart”.

As described earlier, the “annotation information” included in the “comment” is treated in a relatively irregular manner. Here, when a “bookmark A” as the annotation name of the “annotation information” is added to the “comment” that includes the “text A” of the “text information”, the display controller 7 interprets and determines that the “annotation information” represents a bookmark. As a result, the LL-chart display manager 4 is controlled to display an emphasized image line in such a way that a bookmark named “bookmark A” is clearly shown at an appropriate position in the image area 102. Therefore, as illustrated in FIG. 3, the “bookmark A” in the “LL-chart” is displayed in a different manner; for example, the line of the “bookmark A” is highlighted.

Further, the annotation information display manager 8 displays the “annotation information”, included in the “chart 3”, in association with the corresponding “LL-program” in the image area 101. When the “chart 3” includes four of the “annotation information” having respective annotation names representing four bookmarks as “bookmarks A, B, C, and D”, the image area 101 of FIG. 3 shows a layered structure of these four “bookmarks A, B, C, and D” under the “chart 3”. In addition, the sequence of the “bookmarks A, B, C, and D” in the display corresponds to the sequence of the bookmarks in the “chart 3”. That is, from the sequence of the “bookmarks A, B, C, and D” in the display, it is understood that the “chart 3” includes the “bookmarks A, B, C, and D” in this order.

Now, a specific data structure of the “annotation information” is explained with reference to an example of a bookmark. FIG. 4 illustrates an exemplary data structure of the “annotation information” when the “annotation information” is a bookmark. The “annotation information” may include an identifier for being given to each one of the “annotation information” and arbitrary information needed for conducting a predetermined operation based on the “annotation information”. In this example, as shown in FIG. 4, the “annotation information” includes a plurality of information pieces: an identifier, a bookmark name, a sequence-and-layer, a hidden text, data designation information, and text data position information. The bookmark name is identical to an annotation name when the “annotation information” is a bookmark. The sequence-and-layer is the information relating to the sequence and the layer of the “annotation information” designated by the sequence-and-layer designator 13. Other elements will be explained later.

The image area 103 of FIG. 3 is a display image area for indicating, in a list form, the annotation names of a plurality of pieces of the respective “annotation information” included in the “chart 3” in the editing operation, under the instruction from the sequence-and-layer display manager 9. In this list form, the annotation names are indicated in exact accordance with the sequence and the layer designated by the sequence-and-layer display manager 9. So, since the annotation name of the “annotation information” which is not needed to be designated with the sequence and the layer is not necessarily displayed in the image area 103, the LL-program generating apparatus 1 is configured to display the annotation name of the “annotation information” when the “annotation information” is a bookmark.

The exact indication of the sequence and the layer is executed, as exemplarily illustrated in FIG. 3, in a way such that sequential numbers are added to positions in front of the annotation names and the annotation names are aligned in a vertical direction in a sequential order. Each of the sequence and the layer of the sequence-and-layer included in the “annotation information” may be set to an arbitrary initial value. As an example, they may be set according to the real sequence and the real layer of the “annotation information” in the “LL-program”. Therefore, when the “annotation information” has no designation value in the sequence-and-layer, the annotation names in the image area 101 are aligned in the same sequential order with those in the image area 103.

Regarding the selected “annotation information”, various kinds of information are indicated in a text form in the image area 104, by the text display manager 10. The selection of the “annotation information” may be performed by designating, with using the GUI, for example, the annotation name which is being displayed in the image area 101, the image area 102, and the image area 103.

The text displayed in the image area 104 indicates information that may be needed by a user with respect to the “annotation information” selected by the user. For example, as shown in FIG. 3, when the selected “annotation information” is a bookmark such as the “bookmark A”, the text displayed in the image area 104 may include the “text A” of the “text information”, which is linked to the “bookmark A”, and a hidden text included in the bookmark.

Further, the text displayed in the image area 104 may include other information shown in FIG. 4, such as, for example, the identifier, the bookmark, the sequence-and-layer, the data designation information, and the text data position information. In addition, the text displayed in the image area 104 may be editable in the image area 104.

Now, for the sake of better understanding, an exemplary procedure that the LL-program generating apparatus 1 carries out an operation for displaying the screen image 100 of FIG. 3 on the monitor 1h will be explained below in brief. More detailed explanation of operations performed by the LL-program generating apparatus 1 will be made later.

When the LL-program generating apparatus 1 is powered and it enters into a state in which the “project” is selected, only an activated image area is the image area 101, but not the image area 102, the image area 103, and the image area 104, in the screen image 100. At this time, as illustrated in FIG. 3, the image area 101 is in a state of displaying the annotation names of the respective “annotation information” included in the “LL-program”, or the “LL-program” alone. In the case of the “LL-program” alone, the annotation names of the “annotation information” included in the “LL-program” may be indicated in a list form by, as described below, selecting the “LL-program”.

Then, when the user selects the “chart 3” in the image area 101, the “chart 3” is turned in the emphasized display mode. Subsequently, a predetermined part of the “chart 3” is displayed; this example displays a top part of the “chart 3” in the image area 2, as shown in FIG. 3. Further, the image area 3 indicates the annotation names of the respective “annotation information” in accordance with the designated sequence and the layer; in the example, since the sequence and the layer for the “bookmarks A, B, C, and D” of the “annotation information” are not changed, “bookmarks A, B, C, and D” are added with the numbers 1-4 and indicated in the order of their positions in the “LL-program”.

Furthermore, when the user selects the “bookmark A” in the image area 101 or the image area 103, a part of the “LL-chart” to be displayed in the image area 102 is, as illustrated in FIG. 3, a part of the “chart 3”, as the “LL-program”, where the “bookmark A” is added. In other words, this part of the “LL-chart” to be displayed is a part of the chart 3 at a position where the “comment” is added, which includes a bookmark with an annotation name as the “bookmark A”. At the same time, the image area 104 indicates the information with respect to the selected bookmark named “bookmark A” of the “annotation information”, which may needed by the user. In this example, the “text A”, i.e., the “text information”, associated with the bookmark named “bookmark A” and a hidden text included in the bookmark named “bookmark A”, if such a hidden text is implemented. The screen image 100 of FIG. 3 illustrates such a state.

In the LL-program generating apparatus 1, a user can execute operations for creating and editing the “LL-command” and the “annotation information” on the image area 102 by using a convenient input device such as the GUI, a keyboard, etc. For further convenient sake, it can also be possible to implement several other input tools and methods such as, for example, a dialog box, a command menu, a shortcut key, etc.

Now, a discussion will be made for an operation of generating and outputting a readable document with respect to the “chart 3” in the state shown in FIG. 3. In accordance with an arbitrary command such as a user instruction, the LL-program generating apparatus 1 generates the readable document with the above-described text information link manager 11 and outputs it with the readable document output portion 12.

In this instance, the sequence and the layer of the “annotation information” to be output as a readable document correspond to the presently designated sequence and layer. Therefore, in this example, the bookmarks named “bookmarks A, B, C, and D” are placed in this order and in the same layer. Also, these bookmarks named “bookmarks A, B, C, and D” are associated with the “texts A, B, C, and D”, respectively.

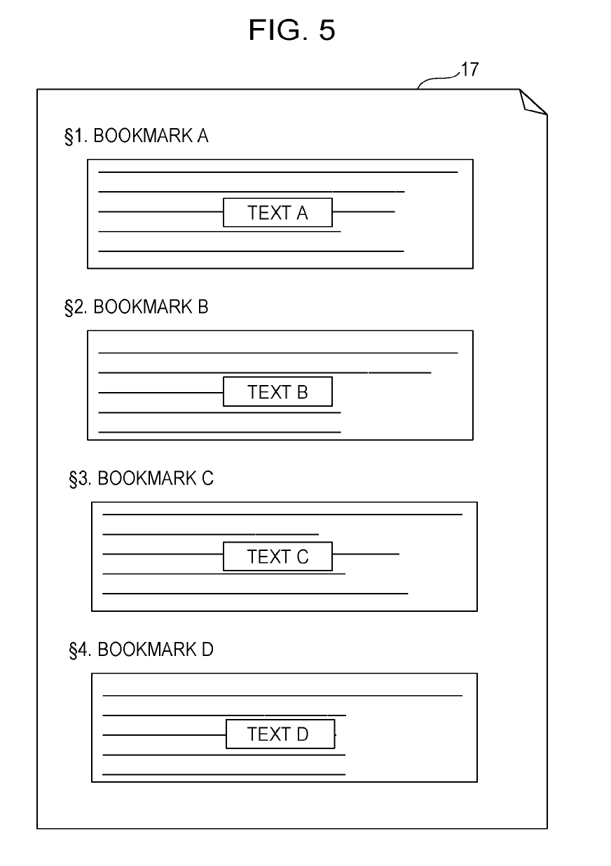

FIG. 5 is a schematic diagram of an exemplary readable document 17 to be generated and output by the LL-program generating apparatus 1. As illustrated in FIG. 5, the readable document 17 has the “texts A, B, C, and D” which are placed in this order and in a form distinguishable from each other, i.e., in four sections. These texts of the “texts A, B, C, and D” are entitled, as section names, the “bookmarks A, B, C and D” which are the annotation names of the corresponding “annotation information”. Further, in front of these section names, arbitrary symbols are given to indicate the sequence and the layer of the “annotation information”; in this example, section numbers “§1” to “§4” are given. In a state of initial settings, a plurality of pieces of the “annotation information” is arranged on the same layer, the section numbers are mere sequential numbers.

In this example, since each one of the “bookmarks A, B, C, and D” has no hidden text, the readable document 17 of FIG. 5 does not indicate a hidden text. When the hidden text is included, however, the text information link manager 11 may associate the hidden text with the “annotation information” so that the hidden texts can be included in the respective sections of the readable document 17 to be output by the readable document output portion 12. The text information linker may associate any further text, such as an external file, for example, with the “annotation information”.

Since the sequence and the layer of the “annotation information” are not altered from the initial settings in the above-described example, the texts corresponding to the “annotation information” are arranged in sequence in exact accordance with their sequence in the “LL-program”, and the sections of the texts are arranged on the same layer. Here, to understand the readable document 17 better, a discussion will be made on a change of the sequence and the layer to be input to the readable document 17.

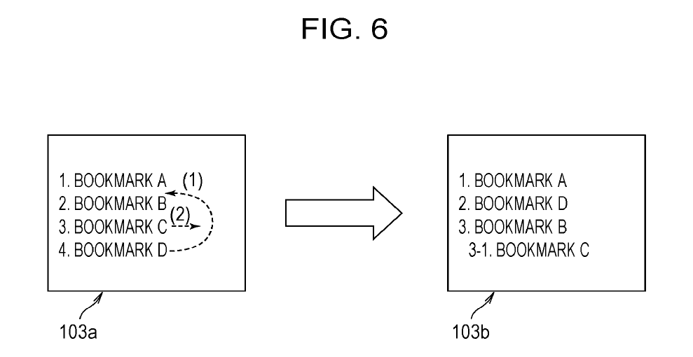

FIG. 6 is a schematic diagram for explaining exemplary manners for designating the sequence and the layer of the annotation name. In FIG. 6, the image area 103 is extracted from FIG. 3, and a change of the sequence and the layer is demonstrated based on image areas 103a and 103b. The image area 103a illustrates a state before a change of the sequence and the layer, and the image area 103a illustrates a state after the change of the sequence and the layer.

In a state of the image area 103a, it is assumed that, by the sequence and the layer designator 13, the sequence of the “bookmark D” is designated to be changed from a backend position to a position between the “bookmarks A and B”, and the layer of the “bookmark C” is altered down to a lower layer, i.e., one lower layer relative to the “bookmark B”. More specifically, as one example, this designation is executed using the GUI in a way such that the “bookmark D” is moved to a position between the “bookmarks A and B” by a drag-and-drop operation, indicated as (1) in the 103a of FIG. 6 and the “bookmark D” is moved rightward also by the drag-and-drop operation, which is indicated as (2) in the 103a of FIG. 6.

As a result, as illustrated in the image area 103b of FIG. 6, the sequence of the “bookmarks A, B, C, and D” is changed, i.e., the “bookmark D” is placed between the “bookmarks A and B”, and the “bookmark C” is indented rightward relative to other annotation names, so that it becomes clear that the “bookmark C” is at the lower layer. In the image area 103b of this example, numbers indicating a new sequence and layers of the “bookmarks A, B, C, and D” after the change are added in front of the annotation names.

The LL-program generating apparatus 1 provides these numbers in exact accordance with those of the sections given when the readable document 17 is generated and output. So, an altered section structure of the readable document 17 will be indicated in the image area 103b. This indication of the image area 103b can be understood as a table of contents and may help understanding of the structure of the readable document to be output without waiting for the generation and outputting of the readable document.

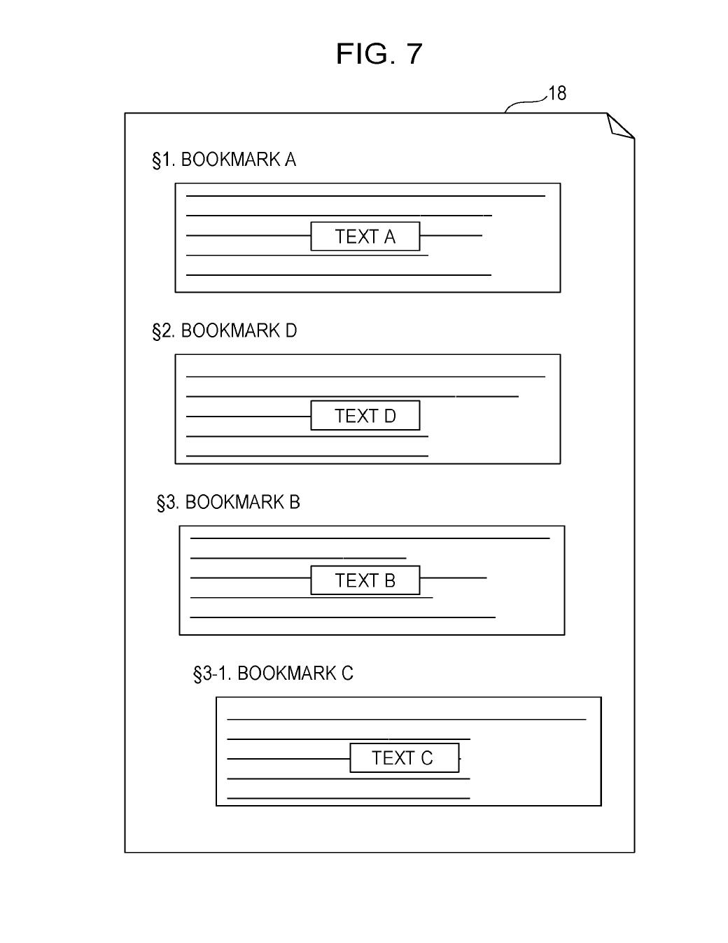

FIG. 7 illustrates an example of a different readable document 18 that is generated and output under the conditions shown in the image area 103b of FIG. 6. In comparison with the readable document 17 of FIG. 6, it is clear that the sequence of the “annotation information” is altered and the layer is indented to a lower layer, in accordance with the designation. Thereby, the contents after the change are easily understandable.

Here, indications of the annotation names in the image areas 101 and 103 are explained below with reference back to FIG. 3. In the LL-program generating apparatus 1, as shown in FIG. 3, the annotation information display manager 8 displays a plurality of the annotation names in the image area 101 in a list form and in association with the “LL-program” that includes a plurality of the corresponding “annotation information”. At the same time, the sequence-and-layer display manager 9 displays in the image area 103 a plurality of the annotation names given to the “annotation information” related to the designation of the sequence and the layer in a list form and in a form such that the plurality of the annotation names appear in accordance with the sequence and the layer contained in the “annotation information”.

The reason for the above two different indications in the image areas 101 and 103 is as follows. Regarding the image area 101, when the user see the indication in the image area 101, the user can easily understand the structure of the “LL-program” to be generated or edited and also relationships among the number of the “LL-programs”. In this example, the indication in the image area 101 sufficiently indicates statuses of the “annotation information”; for example, which “LL-program” they belong to, what kind of “annotation information” is attached to the “LL-program”, and in what sequence the “annotation information” are attached to the “LL-program”. So, the annotation information display manager 8 displays the annotation names in a form such that each one of the annotation name is linked with the corresponding “LL-program” and in a sequence in accordance with the sequence of the “annotation information” in the “LL-program”.

On the other hand, the annotation information display manager 8 is to be used such that the user can easily understand the structure of the readable document to be generated and output, by giving a glance on the indication displayed by the annotation information display manager 8. So, in this example, an indication of only the annotation names associated with the readable document to be output may be sufficient. The sequence is in accordance with that of the readable document to be output. In addition, the layer may also be indicated.

Accordingly, the sequence-and-layer display manager 9 displays the annotation names with respect to the “annotation information” each including a bookmark. At the display, the sequence-and-layer display manager 9 clearly indicated, in appearance, the designated sequence and layer for the “annotation information”. Thus, displays by the annotation information 8 and by the sequence-and-layer display manager 9 are different in style from each other.

However, these two indications of the annotation names in list forms may not necessarily be executed at the same time. As an alternative, one out of the two indications may be sufficient. Selectable setting of the two indications may also be sufficient. For example, the image area 103 is omitted, and the sequence-and-layer designator 13 is configured to designate the sequence and the layer of the “annotation information” on the image area 101.

Now, a discussion will be made on an operation that the LL-program generating apparatus 1 generates the “LL-program” from the basic readable document. It is assumed that the readable document 18 of FIG. 7 is prepared beforehand as a basic readable document in an electronic data form. In this example, the basic readable document is hereinafter referred to as the readable document 18 of FIG. 7, until otherwise specified.

The document data receiver 14 receives the readable document data of the readable document 18 shown in FIG. 7 and transfers it to the LL-program generator 15. The LL-program generator 15 analyses the readable document data, and divides texts included in the readable document data into a plurality of block texts. Further, the LL-program generator 15 generates a number of “comments” that equals to a number of the block texts, and assigns the block texts to the respective “comments” as the “text information”.

The LL-program generator 15 further generates the “annotation information”, i.e., a plurality of bookmarks, and adds them to the respective “comments”. At this time, the annotation name, the sequence, and the layer of each bookmark may be defined automatically based on the title and the section number given to the text which is recognized as a block text during the analysis of the readable document data. In the example of FIG. 7, the “bookmarks A, B, C, and D”, which are the titles attached to the sections, are given as the respective annotation names, and the section numbers “§1”, “§2”, and “§3-1” are given as the sequence and the layer, for example.

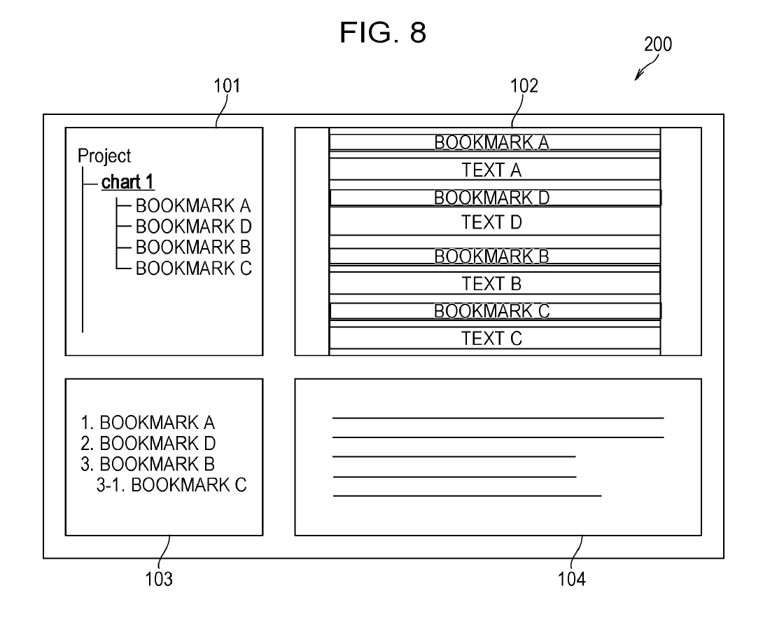

FIG. 8 illustrates a screen image 200 displayed on the monitor 1h of the LL-program generating apparatus 1 of FIG. 1, when the “LL-program” is generated based on the readable document 18 of FIG. 7. As shown in FIG. 8, the screen image 200 contains an image similar to the image of the screen image 100 of FIG. 3, but has slightly different contents in each of the image areas 101-104. Such differences will be explained below.

In FIG. 8, the image area 1 indicates that the “chart 1” is newly added to the “project” and that the “chart 1” includes four of the “annotation information” in the order as shown in FIG. 8. Here, a bookmark is used as each one of four of the “annotation information”. Each of the annotation names, i.e., the “bookmarks A, B, C, and D”, is equal to a corresponding one of the section titles for the respective sections in the readable document 18. The sequence of the annotation names are in accordance with the sequence of the sections in the readable document 18.

In the image area 102, an “LL-program” under creation is indicated as an “LL-chart”. Here, no “LL-command” is implemented yet, and “comments” are generated in association with the sections in the readable document 18. As shown in FIG. 8, a plurality of combinations of the “annotation information” and the “text information” included in the corresponding “comment” are indicated in the image area 102.

Taking an example of an upper-most “comment” in the image area 102, it includes two indications. One is a bookmark having the “bookmark A” as an annotation name, and the other is the “text A” as the “text information” under the “bookmark A”. In this way, this combination of the “annotation information” and the “text information” is generated in association with the section “§1” in the readable document 18. Since the other “bookmarks D, B, and C” are handled in manners similar to the “bookmark A”, as described above, explanations for them are omitted.

Further in FIG. 8, the image area 103 shows a list that indicates the annotation names of the bookmarks representing the generated “annotation information”. Here, each of the “annotation information” has the sequence which is equal to the sequence in the readable document 18. With respect to the layer, the readable document 18 shows that the section “§3-1” followed by the “bookmark C” is on a one-lowered layer from the other sections “§1”-“§3”. Therefore, the “annotation information” having an annotation name as the “bookmark C” is recorded as being on a one-lowered layer, and the image area 103 indicates the section “§3-1” in a manner in which the section “§3-1” is indented to the one-lowered layer.

In the image area 104, no indication is made since the user does not select any one of the “annotation information” at the present time.

In this way, the LL-program generating apparatus 1 is capable of performing an automatic generation of the “LL-program” which is attached with “comments” including the “annotation information” and the “text information” based on the data of the readable document 18 used as a source document. The user can create the “LL-program” into a complete form by successively implementing appropriate “LL-commands” with reference to the texts in the respective sections indicated in the screen image 200. Thereby, the user can create the LL-program in a remarkably efficient manner and reduce errors in the LL-program, such as, for example, an omission of the specification, etc.

Next, an exemplary variation of the LL-program generating apparatus 1 is explained below. The LL-program generating apparatus 1 having this variation displays the text pertinent to the “annotation information” with reference to the data of the readable document recorded as an external file. Here, the external file is defined as electronic data stored separately from the LL-program in the viewpoint of the filing system.

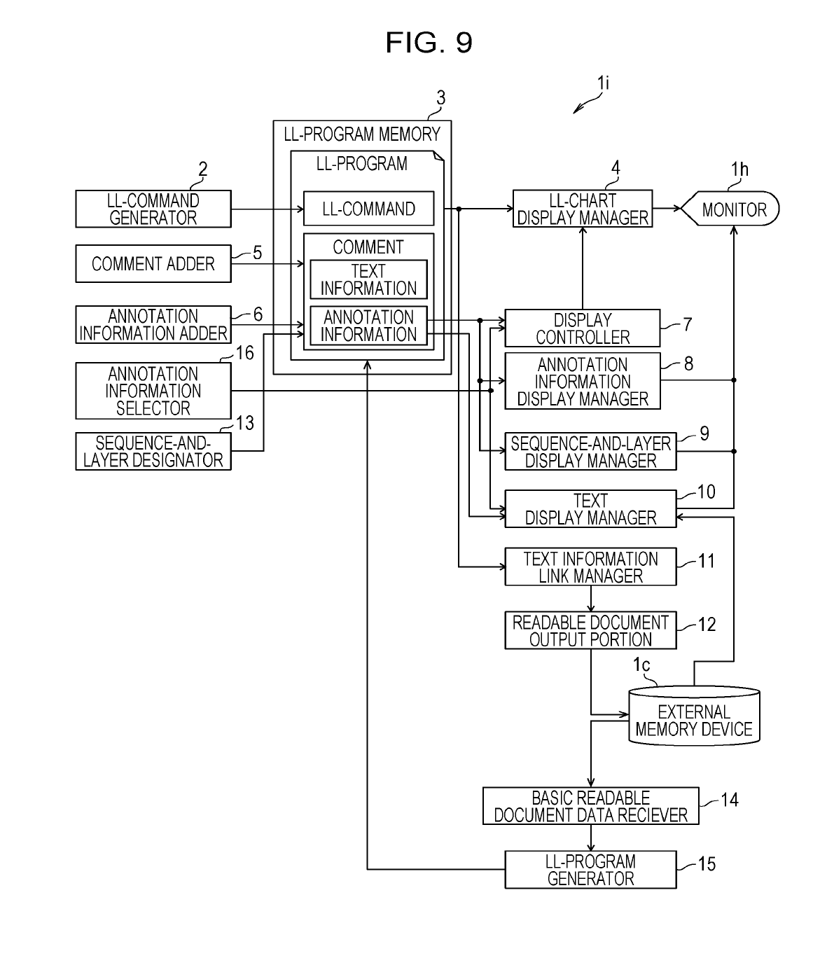

FIG. 9 illustrates an exemplary functional structure of the LL-program generating apparatus 1, including a variation added to the functional structure of FIG. 2. In comparison with the functional structure of FIG. 2, by this variation of FIG. 9, the LL-program generating apparatus 1 allows the text display manager 10 to refer the external memory unit 1c as well as the “annotation information” out of the whole “comment”. Since this is only the difference and other functions and the physical structure remain same, repetitive explanations are omitted.

It is assumed that the data of the readable document 18 shown in FIG. 7 is stored in the external memory unit 1c as the data of the readable document. It is also assumed that the LL-program generating apparatus 1 previously read the LL-programs, such as the “charts 1-4” of FIG. 2, as the project, and the “chart 3” has attachments of the “bookmarks A, B, C, and D” as the “annotation information”.

Here, the bookmark named “bookmark A” is explained in detail, by referring to the data structure of the “annotation information” shown in FIG. 4, in which the “annotation information” is determined as a bookmark. The identifier includes information that uniquely identifies the “annotation information” and also information that identifies a kind of the “annotation information”. The identifier may have an arbitrary structure; for example, if a serial number of the “annotation information” is attached with an alphanumerical symbol indicating a kind of the “annotation information”, the “bookmark A” may be expressed in a way such as “00001-BM”, for example. Here, the value “00001” indicates the serial number of the “annotation information” and the alphanumerical symbol “BM” indicates that it is the bookmark.

The bookmark name is identical to the annotation name and, in this example, it is the “bookmark A”. The value of the sequence-and-layer is determined as “1”, when using, for example, the identical values attached in the image area 103. The hidden text is assumed as not being defined.

Further, the data designation information is the information for specifying the position at which the data of the readable document 18 is present; this readable document 18 is needed to be referred by the bookmark named “bookmark A”, i.e., the “annotation information”. Such information is, for example, information for referring files. By using the data designation information, the LL-program generating apparatus 1 can specify and access the data of the readable document 18 needed to be referred to.

Further, the text data position information is the information for specifying the position of the data of the text in connection with the bookmark named “bookmark A”, in the data of the readable document 18. As an example of the text data position information, a combination of a page number and a line number may be used. Also, a label may be usable when meta data can be embedded in the data of the readable document 18 by using, for example, a markup language. That is, labels for specifying the positions of the respective sections may previously be attached, as meta data, in the data of the readable document 18, so that such labels can be used as the text data position information. By this way, as described later, the position of the text data can be precisely specified even when the data of the readable document 18 is edited. More specifically, the text data position information may designate a specific area of the text data needed, for example, and may add further information to specify the start position of the specific area.

When the “annotation information” is selected by the annotation information selector 9, the text display manager 10 of FIG. 9 according to the present variation refers to the selected “annotation information” that is stored in the LL-program memory 3. Then, the text display manager 10 accesses the data of the readable document 18 stored in the external memory unit 1c, by using the data designation information of the selected “annotation information”. Consequently, the text display manager 10 displays a part of the accessed data of the readable document 18 specified by the text data position information in the image area 104, as the readable document 18. For the image of the display, for example, the text display manager 10 may analyze the data of the readable document 18 and reform the part to be displayed on the monitor 1h according to the results of the analysis. As another example, a specific image viewer for viewing the data of the readable document 18 may be prepared separately, and an image by the image viewer may be embedded in the image area 104. An example of using such an image viewer is explained later.

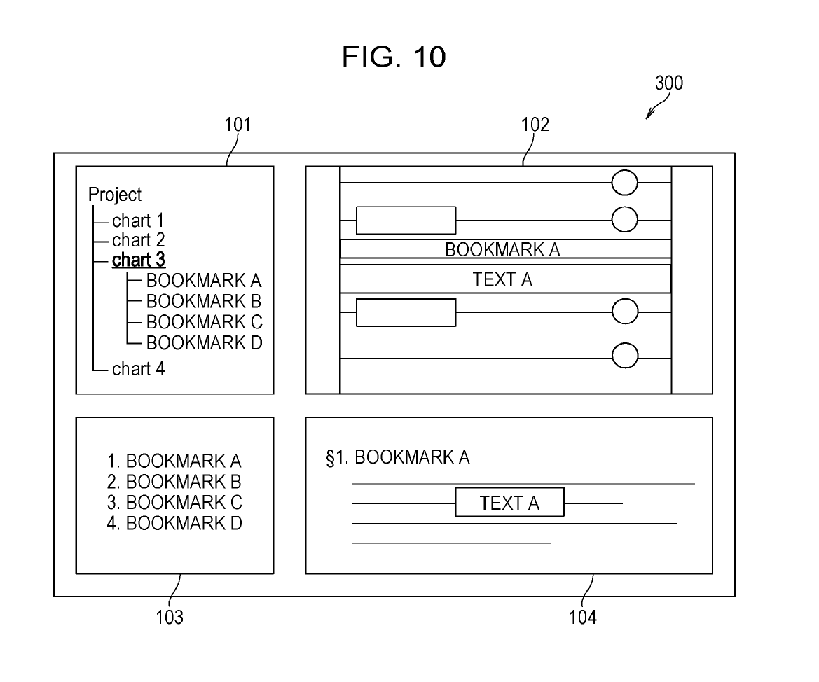

FIG. 10 is an exemplary screen image 300 displayed on a monitor 1h of the LL-program generating apparatus 1 having the above-described variation illustrated in FIG. 9. The screen image 300 of FIG. 10 corresponds to the screen image 100 of FIG. 3 with respect to the LL-program generating apparatus 1 having the function structure 1i of FIG. 2. A difference between FIGS. 3 and 10 is the contents of the image area 104, and other parts are basically identical to each other. As illustrated in FIG. 10, the image area 104 indicates a state in which the bookmark named “bookmark A” is selected by the annotation information selector 9.

In this state, the text display manager 10 displays in the image area 104 the part of the data of the readable document 18, which is the external data; this part of the data corresponds to the bookmark “bookmark A”. In this example, the data of the readable document 18 is displayed in the image area 104 in which the separately prepared image viewer for viewing the data of the readable document 18 is embedded. Thus, as illustrated in FIG. 10, the section “§1” that is a part corresponding to the “bookmark A” in the data of the readable document 18 is displayed in a form identical to an image viewed with a standalone viewer.

So, the data of the readable document 18 can be edited in a form independent from the LL-program, by referring and displaying in the image area 104 the text in the data of the externally stored readable document 18 linked with the specific “annotation information”. The LL-program generating apparatus 1 can reflect such edition in the display.

There may be an exemplary case where a project involves a plurality of members including a programmer to create an LL-program and a designer, who is a different member from the programmer, to write a specification for the LL-program. In such a case, with the above-described LL-program generating apparatus 1 having the variation of FIG. 9, for example, the designer can add a change that reflects a correction in design to the data of the readable document 18 without referring to the details of the LL-program. Also, the programmer can correct the LL-program, for example, by referring to the data of the already-changed readable document 18 on the LL-program generating apparatus 1. In this way, by using the above-described LL-program generating apparatus 1 having the variation of FIG. 9, it becomes possible to work easily and flexibly with changes of the specification of the LL-program, thereby greatly improving productivity and maintenability.

The exemplary embodiments of FIGS. 2 and 9 may not be mutually exclusive but complementary to each other. That is, the LL-program generating apparatus 1 may be provided with both of the functions and operations explained with reference to FIGS. 2 and 9. In this case, the LL-program generating apparatus 1 may allow the user to select the function and operation by the text display manager 10 of FIG. 2 or those by the text display manager 10 of FIG. 9.

As an alternative, the text display manager 10 may perform the operation according to the exemplary embodiment of FIG. 2 when the LL-program is in the process but the data of the readable document 18 is not generated and output. Similarly, the text display manager 10 may perform the operation according to the variation of FIG. 9 when the “LL-program” is in the process and the data of the readable document 18 is already generated and output.

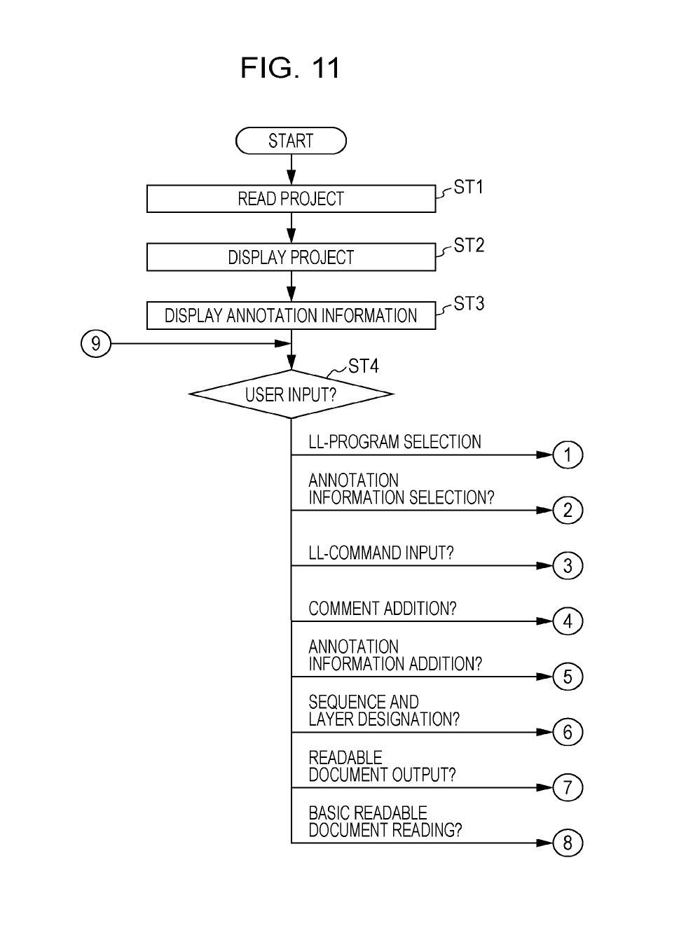

FIGS. 11-19 illustrate exemplary procedures of main operations performed by the LL-program generating apparatus 1 according to the exemplary embodiments of FIGS. 1, 2, and 9. The procedures explained below relate only to a part of the functions to be performed by the above-described LL-program generating apparatus 1 and do not cover every operation performed by the LL-program generating apparatus 1.

FIG. 11 is a flowchart illustrating an exemplary procedure of a basic operation performed by the LL-program generating apparatus 1 of FIG. 1. The LL-program generating apparatus 1 reads a project of the “LL-program”, in step ST1, and displays information related to the project that includes the “LL-program” under its umbrella in the image area 101 in the screen image 100, in step ST2.

Then, the annotation information display manager 8 displays a plurality of the “annotation information” included in the “LL-program” in association with the corresponding “LL-program” in the image area 101, in step ST3.

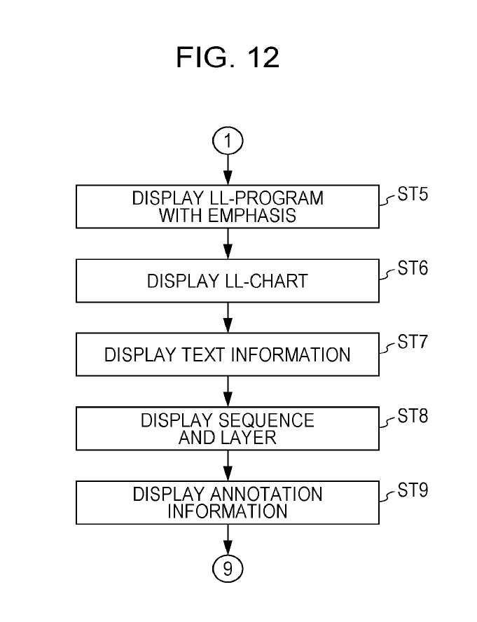

When the user inputs an instruction, in step ST4, the procedure proceeds to a succeeding step in accordance with the instruction. For example, when the user selects, in step ST4, an instruction for editing one of a plurality of the “LL-programs”, the procedure proceeds to step ST5 of FIG. 12.

FIG. 12 is a flowchart illustrating an exemplary procedure of an LL-program selecting operation. When the user selects, in step ST4, a specific “LL-program” to edit out of the plurality of the “LL-programs”, the name of the selected “LL-program” is indicated in the emphasized display mode in the image area 101, in step ST5.

Then, the LL-chart display manager 4 displays, in step ST6, the selected “LL-program” in a form of the “LL-chart” in the image area 102. Subsequently, the LL-chart display manager 4 inserts the “text information” of the “comment” included in the “LL-program” in process into the “LL-chart” being displayed, in step ST7.

In step ST8, the sequence-and-layer display manager 9 displays in the image area 10 a plurality of the annotation names given to a plurality of the respective “annotation information” included in the selected “LL-program” in a form such that each of the plurality of the annotation names appears in exact accordance with the designated sequence and the layer.

In step ST9, the display controller 7 analyses the “annotation information” included in the selected “LL-program” and, in accordance with the result of the analysis, controls the display by the LL-chart display manager 4. Thereby, for example, when the “annotation information” is a bookmark, the “annotation information” is displayed as a bookmark in the image area 102. When the process in step ST9 is completed, the procedure goes back to step ST4 of FIG. 11 to wait again for a user's input of instructions.

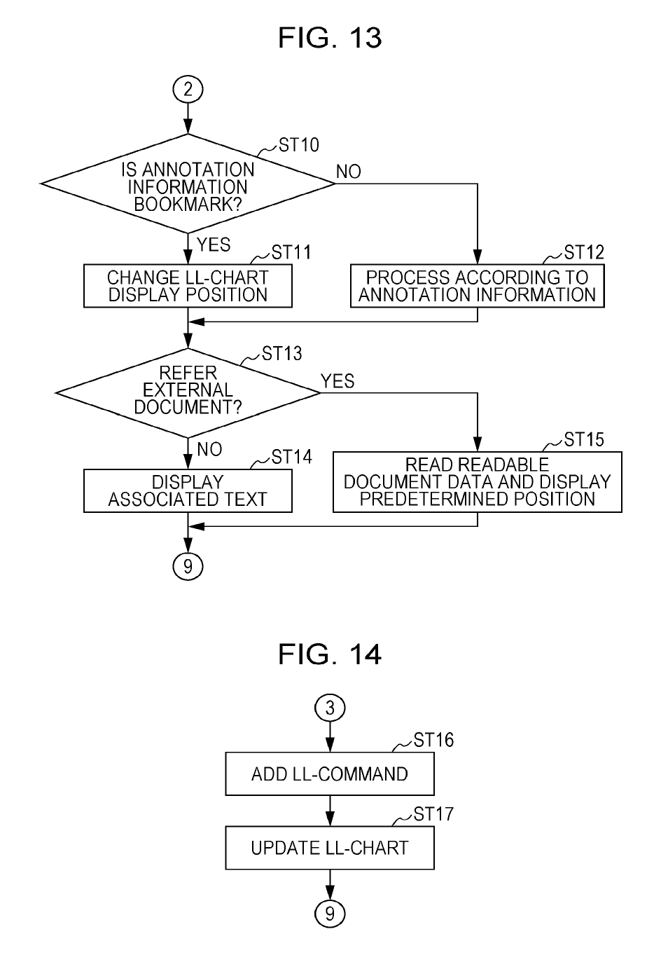

When the user selects, in step ST4, the “annotation information” from the image areas 101-103, the procedure proceeds to step ST 10 of FIG. 13. FIG. 13 is a flowchart illustrating an exemplary procedure of an annotation information selecting operation.

In step ST10, a judgement is executed as to whether or not the selected “annotation information” is a bookmark. When the selected “annotation information” is judged as a bookmark, the procedure goes to step ST11. Then, in step ST11, the display controller 7 controls to change the display by the LL-chart display manager 4 in a way such that a part of the LL-chart to which the selected bookmark is added is displayed in the image area 102.

When the judgement in step ST10 is made such that the selected “annotation information” is not a bookmark, the procedure proceeds to step ST12 and executes, in step ST12, a process in accordance with the “annotation information”. For example, the text display manager 10 displays in a text form various kinds of information with respect to the selected “annotation information” in the image area 104.

After a completion of step ST11 or step ST12, the procedure goes to step ST13 and judges, in step ST13, whether or not the text display manager 10 refers to an external file. When the procedure does not refer the external file, the procedure proceeds to step ST14. In step ST14, the text display manager 10 displays, in a text form, information related to the selected “annotation information” in the image area 104. The information related to the selected “annotation information” includes, as described above, the “text information” included in the “comment” to which the selected “annotation information” is attached, various kinds of texts, etc.

When the text display manager 10 refers to the external file in step ST13, the procedure proceeds to step ST15. In step ST15, the text display manager 10 refers to the selected “annotation information” which is stored in the LL-program memory 3. Further, the text display manager 10 accesses the data of the readable document 18 stored in the external memory unit 1 by using the data designation information of the selected “annotation information”. Then, the text display manager 10 displays in the image area 104 a part of the data of the readable document 18 as the readable document 18; the part of the data of the readable document 18 is specified by the text data position information.

In this exemplary procedure in step ST13, it is predetermined that the above-described exemplary embodiment of FIGS. 1 and 2 and the variation of FIG. 9 are used to be complementary to each other, the LL-program generating apparatus 1 is provided with both of the functions and operations explained above with reference to FIGS. 2 and 9.

The judgement in step ST13 may be executed based on a user's instruction, or may be executed automatically by the LL-program generating apparatus 1 based on various kinds of conditions.

Then, the procedure goes back to step ST4 when completing steps ST14 and ST15, and waits for a user's instruction again in step ST4.

When the user instructs, in step ST4, an input of an “LL-command”, the procedure proceeds to step ST16. FIG. 14 is a flowchart illustrating an exemplary procedure of an LL-command input operation.

In step ST16, the LL-command generator 2 generates a newly additional LL-command based on the user's instruction received. Then, the procedure proceeds to step ST17. The LL-command display manager 4 renews, in step ST17, the image in the image area 102 such that the newly added LL-command is indicated as an LL-chart. Upon a completion of step ST17, the procedure goes back to step ST4, and waits for a user's instruction again in step ST4.

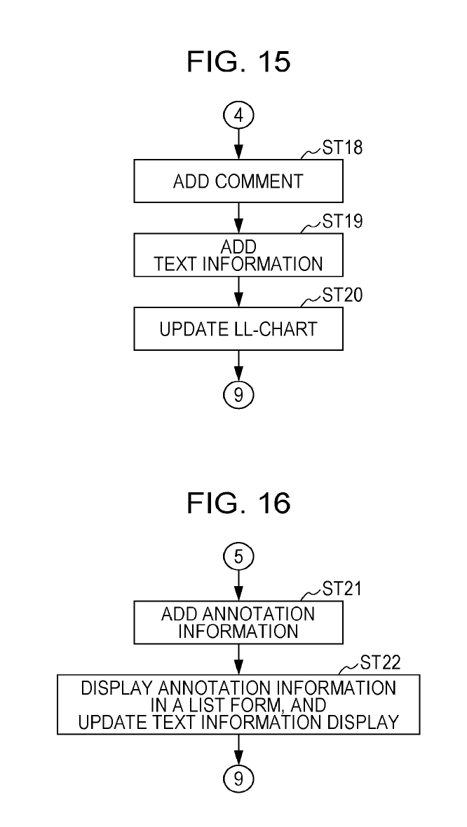

When the user instructs an addition of a “comment”, in step ST4, the procedure proceeds to step ST18 of FIG. 15. FIG. 15 is a flowchart illustrating an exemplary procedure of a “comment” addition operation. The comment adder 5 adds, in step ST18, a “comment” to the LL-program”, and further adds, in step ST19, “text information” to the added “comment”. The procedure then proceeds to step ST20. The LL-chart display manager 4 renews, in step ST20, the image of the image area 102 such that the added “text information” is inserted at a position in the LL-chart corresponding to the position at which the “comment” is attached in the “LL-program” and is displayed in a text form. Upon a completion of step ST 20, the procedure goes back to step ST4 and again waits for a user's instruction.

When the user instructs an addition of “annotation information”, in step ST4, the procedure proceeds to step ST 21 of FIG. 16. FIG. 16 is a flowchart illustrating an exemplary procedure of an “annotation information” addition operation.

In step ST21, the annotation information adder 6 adds the “annotation information” in the “comment” stored in the LL-program memory 3, based on the user input received. Then, the procedure proceeds to step ST22 in which the display is renewed with the updated information.

Various kinds of information indicated in the image areas 101-104 may be renewed: for example, in the image area 101, the list of the annotation names indicated by the annotation information display manager 8; in the image area 102, the indication indicated by the display controller 7; in the image area 103, the list of the annotation names displayed by the sequence-and-layer display manager 9; and, in the image area 104, the display of the texts indicated by the text display manager 10.

Such renewal of the display contents may be executed depending upon a kind of the “annotation information”. Upon completion of step ST22, the procedure goes back to step ST4, and again waits for a user's instruction.

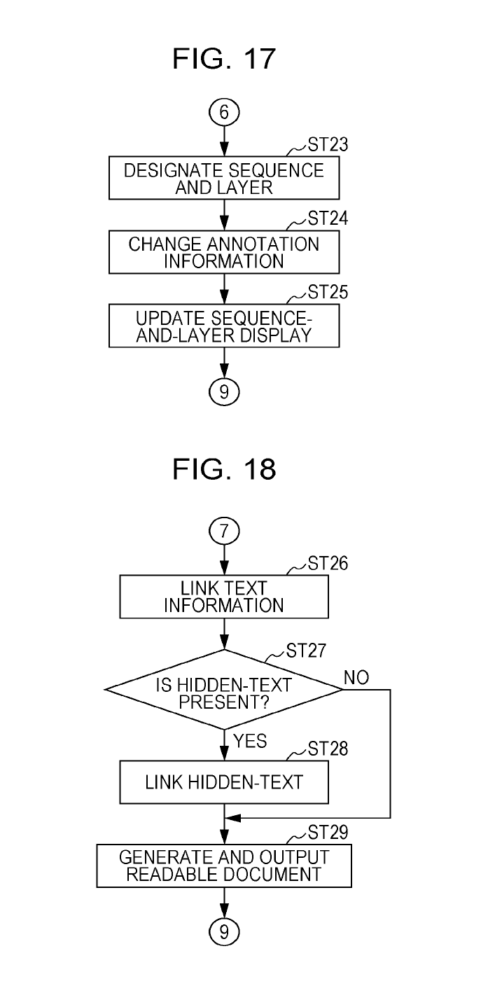

When the user instructs, in step ST4, a designation of the sequence and the layer of the annotation names, the procedure proceeds to step ST23 of FIG. 17. FIG. 17 is a flowchart illustrating an exemplary procedure of a sequence-and-layer designating operation. In step ST23, the sequence-and-layer designator 13 receives designation of the sequence and the layer for the annotation names, and then alters, in step ST24, such that the respective annotation names are rearranged in accordance with the designated sequence and the layer.

Subsequently, the procedure proceeds to step ST25. In step ST25, the display in the image area 103 by the sequence-and-layer display manager 9 is renewed in a form such that designation of the sequence and the layer is executed. Then, upon a completion of step ST25, the procedure goes back to step ST4 to wait again for a user's instruction.

When the user instructs, in step ST4, an output of the readable document 17, the procedure proceeds to step ST26 of FIG. 18. FIG. 18 is a flowchart illustrating an exemplary procedure of a readable document output operation. In step ST26, the text information link manager 11 links the “annotation information” to the respective “text information”.

Then, the procedure proceeds to step ST27. In step ST27, a judgement is executed as to whether or not the respective “annotation information” include hidden texts.

When the respective “annotation information” include the hidden texts and the result of the judgement is YES, the procedure proceeds to step ST28. When the respective “annotation information” do not include the hidden texts and the result of the judgement is NO, the procedure proceeds to step ST29.

In step ST28, the text information link manager 11 links the hidden texts to the “annotation information”. Then, the proceeds to step ST29 in which the readable document output portion 12 generates and outputs the readable document 17 based on the text information and the hidden texts linked with the “annotation information”. Upon a completion of step ST29, the procedure goes back to step ST4 to wait again a user's instruction.

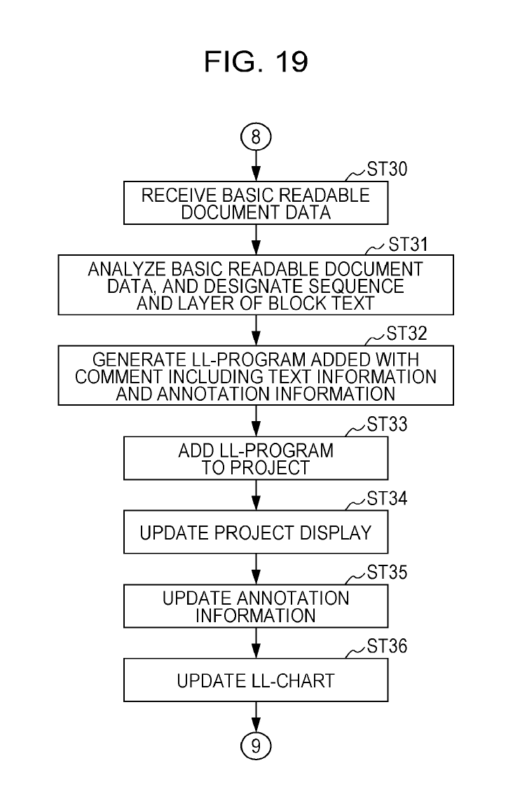

When the user instructs, in step ST4, a reading operation with respect to the readable document 18, the procedure proceeds to step ST30 of FIG. 19. FIG. 19 is a flowchart illustrating an exemplary procedure of a basic readable document reading operation. In step ST30, the readable document data receiver 14 receives the data of the readable document 18 in an electronic form from the external memory unit 1c, or the like, and sends the data to the LL-program generator 15.

Then, the procedure proceeds to step ST31. In step ST31, the LL-program generator 15 analyzes the data of the readable document 18. With the results of the analysis, the LL-program generator 15 divides and specifies the texts included in the data of the readable document 18 into block texts. Further, the LL-program generator 15 designates the sequence and the layer for the respective block texts.

Subsequently, the procedure proceeds to step ST32, the LL-program generator 15 generates a “comment” for each of the block texts in a way such that the “comment” includes the “text information” and the “annotation information” both having the contents of the block text. Thereby, the LL-program generator 15 creates an “LL-program” composed of the “comments”.

Further, the LL-program generator 15 adds the newly generated “LL-program” to the project, in step ST33, and renews the display in the image area 101 in a way such that the name of the added “LL-program” is displayed, in step ST34. Then, the procedure proceeds to step ST35. In step ST35, the annotation display manager 8 renews the display in the image area 101 so that the annotation names of a plurality of respective pieces of the “annotation information”, generated by the LL-program generator 15, are indicated in association with the added LL-program in a list form.

Then, the procedure proceeds to step ST36 in which the LL-chart display manager 4 displays the LL-program as the LL-chart in the image area 102 and the display controller 7 controls the display displayed by the LL-chart display manager 4, so that the display on the LL-chart in the image area 102 is renewed. Then, upon a completion of step ST36, the procedure goes back to step ST4 and again waits for a user's instruction.

It should be understood by those skilled in the art that various modifications, combinations, sub-combinations and alterations may occur depending on design requirements and other factors insofar as they are within the scope of the appended claims or the equivalents thereof.

The following discloses additional aspects relating to the above-described embodiments.

(1) An apparatus for generating a ladder-logic program, comprising:
a comment adder that adds one or more comments, each of which includes text information, to the ladder-logic program;
an annotation information adder that adds annotation information, pertaining to display of the ladder-logic program, to at least one of the one or more comments;
a ladder-logic chart display manager that displays a ladder-logic chart and the text information included in each of the one or more comments, based on the ladder-logic program; and
a display controller that controls display performed by the ladder-logic chart display manager, based on the annotation information added to the at least one of the one or more comments.
(2) The apparatus of (1) further includes:
an annotation information display manager that displays a list form, indicating at least one part of each piece of one or more pieces of the annotation information respectively added to the at least one of the one or more comments, in an area different from an area for displaying the ladder-logic chart and the one or more comments; and
an annotation information selector that selects at least one piece of the annotation information from the list displayed by the annotation information display manager, and wherein the display controller causes the ladder-logic chart display manager to display a part of the ladder-logic chart at a position where the at least one piece of the annotation information selected by the annotation information selector is added.
(3) The apparatus of (2), wherein the annotation information display manager displays the list such that an annotation name, representing the annotation information as the at least one part of each piece of one or more pieces of the annotation information respectively added to the at least one of the one or more comments, is indicated in association with a ladder-logic program name representing the ladder-logic program.
(4) The apparatus of (1)-(3), further comprising: a text information link manager that associates the text information with the annotation information, included in each of the at least one of the one or more comments; and a readable document output unit that outputs a readable document in a form in which one or more pieces of the text information respectively included in the one or more comments are distinguishable on the basis of the annotation information associated with the text information.
(5) The apparatus of (4), wherein:
at least one of the one or more comments includes a hidden text; the text information link manager associates the hidden text with the annotation information, included in each of the at least one of the one or more comments; and
the readable document output unit outputs a readable document in a form in which the hidden texts are distinguishable on the basis of the annotation information associated with the hidden text.
(6) The apparatus of (4), further comprising:
a sequence-and-layer designating unit that designates at least one of a sequence and a layer relating to a plurality of the annotation names indicated in the list, and wherein the readable document output unit outputs the readable document based on the at least one of the sequence and the layer designated by the sequence-and-layer designating unit.

(7) The apparatus of (4), further comprising: a text display manager that displays a text, and

wherein the readable document includes readable document data,
the annotation information includes data designation information for designating the readable document data, and text data position information for designating a position at which text data of the text information associated with the annotation information is located in the readable document data,
the text is related to a predetermined piece of the annotation information, and
the text display manager displays the text based on the data designation information and the text data position information.
(8) The apparatus of (4), further comprising:
a basic readable document data receiver that receives basic readable document data including one or more block texts which are in a form distinguishable from each other; and
a ladder-logic program generator that generates a ladder-logic program that includes one or more comments, which are separated based on the block texts and at least one of which include the annotation information, are added in accordance with the basic readable document data.
(9) The apparatus of (8), wherein the ladder-logic program generator designates the sequence and the layer for the annotation names in accordance with the sequences and the layers of the block texts.
(10) The apparatus of (8), wherein each of the block texts includes the text data.
(11) A computer program stored in a non-transitory computer-readable recording medium including a set of instructions for causing a computer to execute an operation of generating a ladder-logic program, the instructions comprising:
adding one or more comments, each of which includes text information, to the ladder-logic program;
adding annotation information, pertaining to display of the ladder-logic program, to at least one of the one or more comments;
displaying a ladder-logic chart and the text information included in each of the one or more comments, based on the ladder-logic program; and
controlling display performed by a step of displaying, based on the annotation information added to the at least one of the one or more comments.
(12) A method of generating a ladder-logic program, comprising:
adding one or more comments, each of which includes text information, to the ladder-logic program,; adding annotation information, pertaining to display of the ladder-logic program, to at least one of the one or more comments;
displaying a ladder-logic chart and the text information included in each of the one or more comments, based on the ladder-logic program; and
controlling display performed by a step of displaying, based on the annotation information added to the at least one of the one or more comments.
(13) A non-transitory computer-readable medium storing a set of instructions for causing a computer to execute a ladder-logic program generating operation, the operation comprising:
adding one or more comments, each of which includes text information, to the ladder-logic program; adding annotation information, pertaining to display of the ladder-logic program, to at least one of the one or more comments;
displaying a ladder-logic chart and the text information included in each of the one or more comments, based on the ladder-logic program; and
controlling display performed by a step of displaying, based on the annotation information added to the at least one of the one or more comments.

1. An apparatus for generating a ladder-logic program, comprising:
a comment adder that adds one or more comments, each of which includes text information, to the ladder-logic program;
an annotation information adder that adds annotation information, pertaining to display of the ladder-logic program, to at least one of the one or more comments;
a ladder-logic chart display manager that displays a ladder-logic chart and the text information included in each of the one or more comments, based on the ladder-logic program; and
a display controller that controls display performed by the ladder-logic chart display manager, based on the annotation information added to the at least one of the one or more comments.

2. The apparatus according to claim 1, further comprising:
an annotation information display manager that displays a list, indicating at least one part of each piece of one or more pieces of the annotation information respectively added to the at least one of the one or more comments, in an area different from an area for displaying the ladder-logic chart and the one or more comments; and
an annotation information selector that selects at least one piece of the annotation information from the list displayed by the annotation information display manager, and
wherein the display controller causes the ladder-logic chart display manager to display a part of the ladder-logic chart at a position where the at least one piece of the annotation information selected by the annotation information selector is added.

3. The apparatus according to claim 2, wherein the annotation information display manager displays the list such that an annotation name, representing the annotation information as the at least one part of each piece of one or more pieces of the annotation information respectively added to the at least one of the one or more comments, is indicated in association with a ladder-logic program name representing the ladder-logic program.

4. The apparatus according to any one of claims 1-3, further comprising:
a text information link manager that associates the text information with the annotation information, included in each of the at least one of the one or more comments; and
a readable document output unit that outputs a readable document in a form in which one or more pieces of the text information respectively included in the one or more comments are distinguishable on the basis of the annotation information associated with the text information.

5. The apparatus according to claim 4, wherein:
the text information link manager associates a hidden text with the annotation information, included in each of the at least one of the one or more comments; and
the readable document output unit outputs a readable document in a form in which the hidden texts are in a form distinguishable on the basis of the annotation information associated with the hidden text.

6. The apparatus according to claim 4, further comprising:
a sequence-and-layer designating unit that designates at least one of a sequence and a layer relating to a plurality of the annotation names indicated in the list, and
wherein the readable document output unit outputs the readable document based on the at least one of the sequence and the layer designated by the sequence-and-layer designating unit.

7. The apparatus according to claim 4, further comprising:
a text display manager that displays a text, and
wherein the readable document includes readable document data,
the annotation information includes data designation information for designating the readable document data, and text data position information for designating a position at which text data of the text information associated with the annotation information is located in the readable document data,
the text is related to a predetermined piece of the annotation information, and
the text display manager displays the text based on the data designation information and the text data position information.

8. The apparatus according to claim 4, further comprising:
a basic readable document data receiver that receives basic readable document data including one or more block texts which are in a form distinguishable from each other; and
a ladder-logic program generator that generates a ladder-logic program that includes one or more comments, which are separated based on the block texts and at least one of which include the annotation information, are added in accordance with the basic readable document data.

9. The apparatus according to claim 8, wherein the ladder-logic program generator designates the sequence and the layer for the annotation names in accordance with the sequences and the layers of the block texts.

10. The apparatus according to claim 8, wherein each of the block texts includes the text data.

11. A method of generating a ladder-logic program, comprising:
adding one or more comments, each of which includes text information, to the ladder-logic program;
adding annotation information, pertaining to display of the ladder-logic program, to at least one of the one or more comments;
displaying a ladder-logic chart and the text information included in each of the one or more comments, based on the ladder-logic program; and
controlling display performed by a step of displaying, based on the annotation information added to the at least one of the one or more comments.

12. A non-transitory computer-readable recording medium storing a program including a set of instructions for causing a computer to execute a ladder-logic program generating method, comprising:
adding one or more comments, each of which includes text information, to the ladder-logic program;
adding annotation information, pertaining to display of the ladder-logic program, to at least one of the one or more comments;
displaying a ladder-logic chart and the text information included in each of the one or more comments, based on the ladder-logic program; and
controlling display performed by the displaying, based on the annotation information added to the at least one of the one or more comments.

13. An apparatus for generating a ladder-logic program, comprising:
a non-transitory memory; and
circuitry configured to
add one or more comments, each of which includes text information, to the ladder- logic program,
add annotation information, pertaining to display of the ladder-logic program, to at least one of the one or more comments, and
instruct display of a ladder-logic chart and the text information included in each of the one or more comments, based on the ladder-logic program, wherein
the circuitry controls the display based on the annotation information added to the at least one of the one or more comments.
